(19) United States
(12) Patent Application Publication
(10) Pub. No.: US 2016/0030777 A1
(43) Pub. Date: Feb. 4, 2016

(54) ROGER - Repeated Oxygen Generation Exhalation Respirator

(71) Applicant: Roger J. Cichon, Chicago, IL (US)

(72) Inventor: Roger J. Cichon, Chicago, IL (US)

(21) Appl. No.: 14/806,588

(22) Filed: Jul. 22, 2015

Related U.S. Application Data
(60) Provisional application No. 62/027,596, filed on Jul. 22, 2014.

(51) Int. Cl. A62B 18/02; A62B 9/06; A62B 18/08; A62B 7/00

(52) U.S. Cl. CPC A62B 18/02; A62B 7/00; A62B 9/06; A62B 18/084

(57) ABSTRACT

A face mask comprising an emergency breathing apparatus to protect a user's eyes and nose and recirculate oxygen in a person's breath in a drowning or smoke-filled situation comprising very thin material that fits over the top of the user's head protecting the eyes and nose and a bladder that is insertable into a user's mouth.

### CLAIM OF PRIORITY

This patent application claims priority under 35 USC 119 (e) (1) from U.S. Provisional Patent Application Ser. No. 62/027,596 filed Jul. 22, 2014, of common inventorship herewith entitled, “The Roger—Repeated Oxygen Generation Exhalation Respirator,” which is incorporated herein by reference as though the same were set forth in its entirety.

### FIELD OF THE INVENTION

The present invention pertains to the field of breathing, and more specifically to the field of oxygen generating devices.

### BACKGROUND OF THE INVENTION

The prior art has put forth several designs for oxygen generating devices. Among these are:

U.S. Pat. No. 6,543,450 to John T. Flynn describes a simple, lightweight and easily deployable mask for use in modern fires. The mask covers a wearer's face and includes a peripheral adhesive seal for preventing contaminants from effecting the wearer's visual or respiratory systems. The peripheral seal comprises an adhesive band employing the skin adhesive commonly used in surgical masks. The adhesive band provides for closed attachment of the mask to the brow, temporal area, cheek, over the jaw and down under the chin. The mask is anchored firmly to the ears of a wearer by resilient straps. Thus attached, the mask seals the eyes, nasal passages and mouth from a toxic external environment. The mask includes an intermediate seal separating the mask into separate visual and respiratory portions. The mask includes a particulate filter impregnated with a transitional metal oxide catalyst and one or more frangible vials filled with perfluorocarbon saturated with oxygen to filter out particulates, absorb toxic chemicals and provide a source of oxygen to the wearer.

U.S. Pat. No. 4,669,462 to Donald K. Marshall describes an elongated and truncated cone like thermoplastic tube which terminates at its base end in a ring that fits over a wearer's face and is held there by elastic bands. The lower end of the cone or trunk like tube terminates in a flexible ring which fits over an aerosol type container filled with compressed breathable gas.

U.S. Pat. No. 4,440,163 to Gabriel Spergel describes an emergency escape breathing apparatus comprising a rigid and transparent face mask attachable to a wearer's head, a pressurized bottle supply of air or oxygen enriched air adapted to be fed to said mask by a flow control assembly. Said assembly includes a rupturable diaphragm valve and a pressure reducing reservoir. The valve at one end is connected to the mouth of the pressurized bottle and at the other end is connected to a reservoir inlet. A flexible hose at one end is connected to the face mask and at the other end is connected to the outlet of the reservoir. The assembly is adapted to provide conditions of pressure and gas content within the mask for respiratory requirements for predetermined brief periods of time to bridge the emergency interval. The face mask has a functioning exhalation valve and is provided with filters to eliminate inhalation of toxic elements in the ambient air. The apparatus is foldable into a compact unit and discardable after a single usage.

None of these prior art references describe the present invention.

### SUMMARY OF THE INVENTION

It is an object of the present invention to provide a face mask comprising an emergency breathing apparatus to protect a user's eyes and nose and recirculate oxygen in a person's breath in a drowning or smoke-filled situation.

### BRIEF DESCRIPTION OF THE DRAWINGS

FIG. 1 is a functional prototypical view showing a user wearing the mask of the present invention with the thin head covering protecting the wearer's eyes and nose and the bladder portion inserted in a user's mouth and portraying how the air bladder expands and contracts with one's breathing.

FIG. 2 is an illustrative prototypical view showing the mask made of thin material with an expandable and contractible air bladder inside a packet.

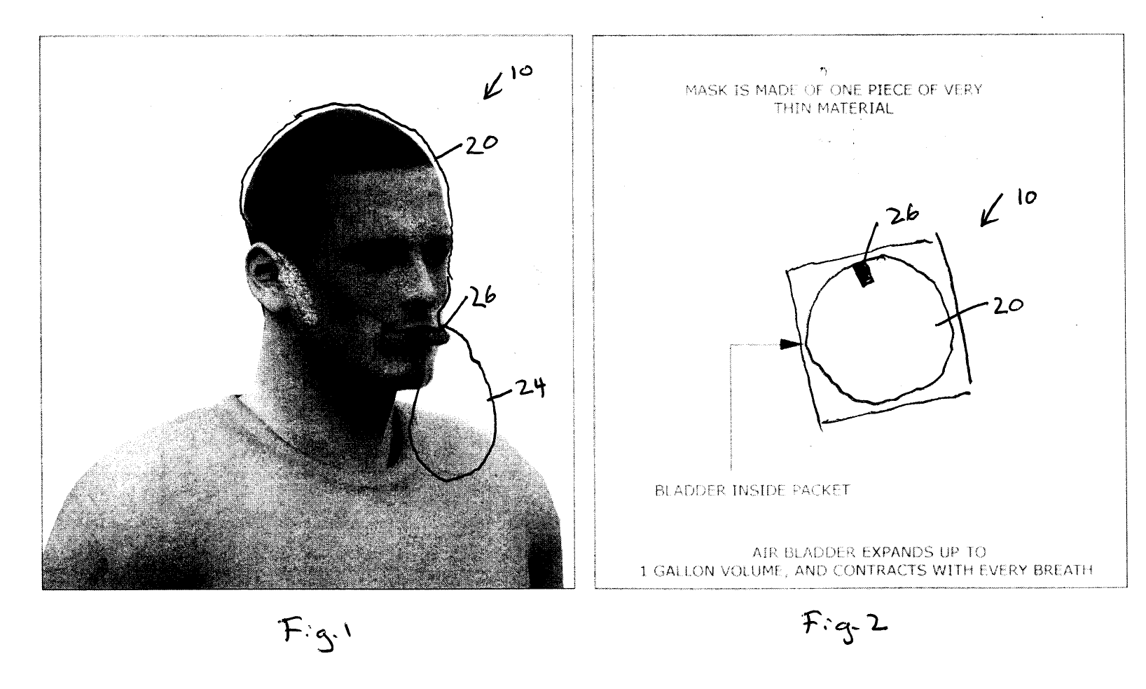

### DETAILED DESCRIPTION OF THE INVENTION

Fires in homes and buildings occur frequently and cause devastating losses, injuries and deaths. Perhaps the most terrifying aspect of a fire is the rapidity with which it spreads. When a fire gets going, individuals in the building become blinded by thick and toxic smoke which they have to breathe when attempting escape. An enclosed fire literally deprives its victims of their senses and in doing so, eventually kills them. Those victims who are fortunate enough to survive a fire often face emotional and financial trauma. Their homes and possessions are gone and in the worst cases, one or more loved ones lost.

The statistics are sobering. The stories are tragic. The number one cause of death related to fires is smoke inhalation. Approximately fifty to eighty percent of fire deaths result from smoke inhalation injuries rather than burns. Smoke inhalation damages the body by simple asphyxiation, chemical irritation, chemical asphyxiation or a combination of the aforementioned cases. Even with sufficient warning of a fire, a dangerous amount of smoke is quickly inhalable, resulting in damage to a body if one does not receive oxygen immediately after breathing in the smoke.

The present invention, hereinafter referred to as The Roger—Repeated Oxygen Generation Exhalation Respirator, or simply, The Roger, is an oxygen generating device that is specially configured to provide an emergency breathing apparatus to recirculate oxygen in a person's breath in a drowning or smoke-filled situation, and to smoke or water inhalation. The Roger provides consumers with a readily accessible means of attaining oxygen in the event of such dangerous situations. The Roger is readily available to an individual at a moment's notice in the event of a fire or water emergency.

The device 10 comprises a face mask 20 of very thin material that fits over the top of the user's head protecting the eyes and nose and an expandable bladder 24 that is insertable into a user's mouth through hollow cylindrical mouthpiece 26. Compact and circular, The Roger measures approximately six to nine inches in length, four to six inches in width, one half inch in depth and twenty to thirty inches in circumference. When expanded, the Roger 10 takes the form of a wearable mask 20 that fits over the top of a user's head protecting the user's eyes and nose and an bladder 24 insertable into the user's mouth by hollow cylindrical mouthpiece 26. Fabricated of clear rubber or clear plastic polymer materials, the present invention comprises an eye and nose protector integrally attached to a hollow cylindrical mouthpiece 26 which is a snorkel like mouth covering with a balloon type air bladder 24. The air bladder 24 is capable of receiving a person's breath. The Roger allows a user to recycle his or her own oxygen flow to restore clear breathing and prevent the inhalation of smoke, water or other toxic material. Placing the present invention on one's face so the eyes and nose are protected from swirling smoke, the mouth piece 26 with air bladder 24 is positioned in the user's mouth. A user slowly inhales and then exhales. As breath fills the air bladder on the exhale, it is redirected as an oxygen and carbon dioxide mix on the inhale. The Roger remains in place until the individual has reached a safe smoke free area and proper breathing is restored. The Roger is conveniently stored in an easily accessible location in the event of a fire, readily available to don at a moment's notice.

The Roger expands instantly to a fully functional breathing apparatus, helping ensure that individuals exposed to smoke are breathing clean air before the smoke can cause any damage. The

Roger is an invaluable front line defensive aid in the event of a fire, helping to alleviate injuries and eliminate the tragic possibility of succumbing to smoke inhalation. The Roger is highly essential in times when fire department response is increased.

The Roger also is highly functional and effective for use in water related emergencies and preventing drowning incidents. With the present invention sewn into or otherwise placed in one's swimming garments, the present invention is immediately placed on one's face to prevent water accumulation in the lungs.

Although this invention has been described with respect to specific embodiments, it is not intended to be limited thereto and various modifications which will become apparent to the person of ordinary skill in the art are intended to fall within the spirit and scope of the invention as described herein taken in conjunction with the accompanying drawings and the appended claims.

1. An emergency breathing device comprising a face mask to protect a user's eyes and nose and recirculate a person's breath containing oxygen in a drowning or smoke-filled situation comprising a face mask of very thin material that fits over the top of the user's head protecting the eyes and nose and a hollow cylindrical mouthpiece insertable into a user's mouth, wherein the mouthpiece is connected to a bladder and the bladder is capable of expanding to receive a user's breath.

2. The emergency breathing device of claim 1, wherein the device is compact and circular when collapsed, and comprises a wearable mask that fits over the top of a user's head protecting the user's eyes and nose and a hollow cylindrical mouthpiece insertable into a user's mouth, wherein the mouthpiece is connected to a bladder and the bladder is capable of expanding to receive a user's breath.

3. The emergency breathing device of claim 1, fabricated of clear rubber or clear plastic polymer material.

4. The emergency breathing device of claim 1, measuring approximately six to nine inches in length, four to six inches in width, one half inch in depth and twenty to thirty inches in circumference, when expanded.
